(19) United States
(12) Patent Application Publication
(10) Pub. No.: US 2011/0309939 A1
(43) Pub. Date: Dec. 22, 2011

(54) UNIT FOR MONITORING AND/OR SIGNALING OR VISUALIZING OPERATING PARAMETERS OF A GAS-INSULATED SWITCHGEAR SYSTEM

(75) Inventors: Jürgen GLOCK, Hirschberg (DE); Klaus Hendrichs, Mannheim (DE); Lothar Heinemann, Hirschberg (DE)

(73) Assignee: ABB Technology AG, Zurich (CH)

(21) Appl. No.: 13/163,310

(22) Filed: Jun. 17, 2011

Related U.S. Application Data
(63) Continuation of application No. PCT/EP2009/008530, filed on Dec. 1, 2009.

(30) Foreign Application Priority Data
Dec. 19, 2008 (DE) 10 2008 063 682.7

(51) Int. Cl. G08B 17/00; G08B 21/00

(52) U.S. Cl. 340/584; 340/657

(57) ABSTRACT

Exemplary embodiments are directed to a monitoring unit and method for monitoring and/or signaling or visualizing a plurality of operating parameters of a gas-insulated switchgear system, where a current and voltage supply unit are located in the housing of the monitoring unit. At least one measurement cell capturing the density or the pressure of a protective gas present in the gas chamber of the gas-insulated switchgear system is also included in the monitoring unit. A processing unit processing the parameters captured by the measurement cell. The monitoring unit also includes a unit for measuring partial discharge and/or a unit for capturing an arc fault arising in the gas chamber of the switchgear system, and an interface for transferring analog and/or digital values.

### RELATED APPLICATIONS

This application claims priority as a continuation application under 35 U.S.C. §120 to PCT/EP2009/008530, which was filed as an International Application on Dec. 1, 2009 designating the U.S., and which claims priority to German Application 10 2008 063 682.7 filed in Germany on Dec. 19, 2008. The entire contents of these applications are hereby incorporated by reference in their entireties.

### FIELD

The disclosure relates to switchgear assembly, such as, a unit for monitoring and/or signaling/visualizing a plurality of operating parameters of a gas-insulated switchgear assembly, for use in density monitoring, for detection of an arc and for measurement of the partial discharge in an inert gas in gas area.

### BACKGROUND INFORMATION

A component which is filled with SF₆ (sulfurhexafluoride) inert gas in a gas-insulated switchgear assembly is monitored by using various sensors and monitors which can measure the density of the SF₆ gas and the partial discharge, and can identify an arc.

Gas density monitors can be used for density measurement, and have switching contacts and an analog display. The switching signals, which are produced by the switching contacts, only indicate that a specific limit value has been undershot, and are designated as a warning or block signal. These signals are included in the control system of the switchgear assembly signal in order, for example to avoid unsafe operating states.

Alternatively, gas density sensors can be used which emit a low analog signal, for example a 4-20 mA signal. This allows continuous monitoring of the gas density. The low analog signal from a monitor is converted by an evaluation unit to a discrete switching signal for early identification of an SF₆ gas leakage. The evaluation unit can also be designed to carry out a trend calculation by means of conventional methods as is described by way of example in DE 102006050938 A1.

For arc identification, the light from a fault arc is detected by an optical sensor which is arranged in the gas area of the gas-insulated switchgear assembly, and is passed, for example via optical waveguides, to an electronic evaluation unit. The evaluation unit evaluates the signal determined by the optical sensor and produces an appropriate signal which is used to disconnect voltage from the affected gas area.

Partial discharges can occur in high-voltage switchgear assemblies because of non-homogeneous fuel profiles and isolation defects. A further sensor is arranged in the gas area of the gas-insulated switchgear assembly in order to measure the partial discharge. UHF (ultra high-frequency) sensors can be used for this purpose, with the partial discharges being measured by typical measurement receivers in the range from about 100 kHz to several MHz.

The detection unit for partial-discharge measurement can be linked by means of an additional serial interface to a superordinate display and monitoring unit, to allow the measured data to be displayed.

Under conventional techniques, a plurality of sensors and evaluation units are used to carry out these monitoring tasks as discussed above. A monitoring system which contains these individual components has been proposed, for example, in “PowerGrid Europe 2007 “Online Condition Monitoring System for Three Phase Encapsulated Gas Insulated Switchgear” and in the document “CB Watch-2 Modular Circuit Breaker Monitoring System” from the company AREVA.

Because of the installation and material costs as well as the maintenance effort, the installation of the respective separate sensors, as described above, for density monitoring of the SF₆ gas for detection of an arc and for measuring the partial discharge of the inert gas in gas-insulated switchgear assemblies has been found to be complex and costly.

### SUMMARY

An exemplary monitoring unit is directed to monitoring and/or signaling/visualizing a plurality of operating parameters of a gas-insulated switchgear assembly is disclosed. The monitoring unit comprises a current and voltage supply unit, which is located in a housing of the monitoring unit; at least one measurement cell for detection of a density or pressure of an inert gas which is located in a gas area of the gas-insulated switchgear assembly; and a processing unit that processes parameters detected by the measurement cell. The monitoring unit also comprises at least one of: an interface for the transmission of analog and digital values; a unit for partial-discharge measurement; and a unit for detection of a fault arc which has occurred in the gas area of the switchgear assembly.

An exemplary method for monitoring a plurality of operating parameters of gas-insulated switch gear assembly is disclosed. The method performed by a monitoring unit comprises measuring a valve for at least one of temperature, pressure, density; processing the measured values, comparing the processsed values to a limit value to detect an overshoot or undershoot of the limit values; and emitting a warning or a blocking signal based on the comparison.

### BRIEF DESCRIPTION OF THE DRAWINGS

The subject matter of the disclosure will be explained in more detail in the following text with reference to exemplary embodiments that are illustrated in the attached drawings in which:

FIG. 1 illustrates a monitoring unit in accordance with an exemplary embodiment; and

FIG. 2 illustrates a communication interface in accordance with an exemplary embodiment.

### DETAILED DESCRIPTION

Accordingly, exemplary embodiments of the present disclosure is based on the object of specifying a unit for monitoring and/or signaling/visualizing a plurality of operating parameters of a gas-insulated switchgear assembly, (e.g., a monitoring unit), which determines and processes data in a simple and cost-effective manner, and can transmit data to a superordinate unit.

An exemplary monitoring unit of the present disclosure is directed to monitoring and/or signaling/visualizing a plurality of operating parameters of a gas-insulated switchgear assembly. The monitoring unit includes a current and voltage supply unit, which is located in the housing of the monitoring unit, a measurement cell (e.g., a pressure or density measurement cell) for detection of density or pressure of an inert gas which is located in the gas area of the gas-insulated switchgear assembly, and a microprocessor that processes the parameters detected by the measurement cell and transmits them to at least one analog display unit. Furthermore, the monitoring unit has a unit for temperature measurement and/or temperature compensation and at least two binary switching contacts, which are connected to the output of the microprocessor.

The advantages which can be achieved by the exemplary embodiments of the present disclosure are based on the combination of the functionalities described herein in a monitoring unit resulting in a compact appliance for determination and processing of all the relevant data for the gas-insulated switchgear assembly.

This data can be made available to the control and maintenance personnel in a simple and cost-effective manner, for example via a communication interface. Furthermore, the combination of the functionalities in a monitoring unit minimizes the number of gas passageways on the switchgear assembly, and this has an advantageous effect on the susceptibility of the switchgear assembly to leakages.

According to the present disclosure, any combination of the following functions can be integrated into an exemplary monitoring unit:
density measurement of the inert gas in the switchgear assembly, combined with an analog and/or digital display,
continuous and/or discrete-value signaling,
detection of a fault arc in the gas area of the switchgear assembly, and
measurement of the partial discharge in the switchgear assembly.

The determined data is in this case processed by means of a microprocessor or microcontroller, which is integrated in the housing of the monitoring unit. The microprocessor is connected to digital and/or analog display apparatuses, which are located on the monitoring unit and are provided to display the processed data as messages and alarms, and/or to provide such data for a superordinate display and monitoring unit.

In a further embodiment of the present disclosure, a unit for temperature measurement and/or temperature compensation can be integrated in the monitoring unit, thus making it possible to compensate for the measurement errors caused by heating, by the current flow, by solar radiation, and by moisture.

In another exemplary embodiment of the present disclosure, the monitoring unit can be connected by means of an integrated communication interface via a fieldbus, which is provided in the switchgear assembly, to the superordinate system, for example a control and implementation system, or monitoring PC. In this case, the communication can be based on the standardized switchgear assembly protocol IEC61850.

The data can also be transmitted via an Ethernet or via a PowerLine network or a radio transmission path. If the communication between the monitoring unit and the superordinate system takes place via the PowerLine network, the supply line can be used not only to feed the monitoring unit with current and voltage, but also for data transmission.

In another exemplary embodiment of the present disclosure, the monitoring unit can be provided for the configuration of different limit values and response thresholds, thus allowing the monitoring unit to configure different standard gas densities and response thresholds for the switching signals, for example as warning and/or blocking messages.

In a further embodiment of the present disclosure, the monitoring unit has means for detection of a fault arc which has occurred in the gas area of the switchgear assembly.

In an exemplary monitoring unit according to the present disclosure, the arc is detected using an optical sensor, which can be located on the monitoring unit according the disclosure, to detect the light from the fault arc, and to supply a detection signal to the microprocessor for further processing.

In another exemplary embodiment of the monitoring unit of the present disclosure, the fault arc in the gas area of the switchgear assembly is detected by using the pressure of the inert gas or insulating gas (e.g., SF₆ gas) in the switchgear assembly, as a criterion for the presence of an arc. For this purpose, either the pressure is detected directly, or is determined from a density signal that is provided, via temperature compensation. By way of example, this method is described in DE 199 08 541 A1, which is hereby incorporated in its entirety by reference.

An exemplary partial-discharge measurement cell, which is in the form of an ion detector and projects into the gas area of the switchgear assembly, can be provided in the monitoring unit of the present disclosure, in order to measure the partial discharge of the inert gas in the gas area of the switchgear assembly. In this case, the ion detector is provided in order to verify the decomposition product hydrogen fluoride which is created in the event of a partial discharge of the inert gas. This method is described, for example, in DE 41 12 896 A1, which is hereby incorporated in its entirety by reference.

The methods described above for determining the partial discharge can alternatively be carried out by means of a UHF measurement using the monitoring unit of the present disclosure.

Furthermore, an exemplary monitoring unit of the present disclosure can include output contacts, in which case an adaptable analog scale can also be provided.

An exemplary monitoring unit of the present disclosure can adjust different units, reference parameters, and alarm thresholds through programming the microprocessor, which is integrated in the monitoring unit, and this programming can be carried out via the Ethernet or PowerLine interface that is provided.

In another exemplary embodiment of the monitoring unit of the present disclosure, a mechanical switching contact can be provided for the density monitoring function of the SF₆ inert gas and, for example, can be in the form of a microswitch. The use of the mechanical switching contact can be specified for safety reasons when it is not permissible to output the signal that is produced solely as analog signal or via a bus protocol.

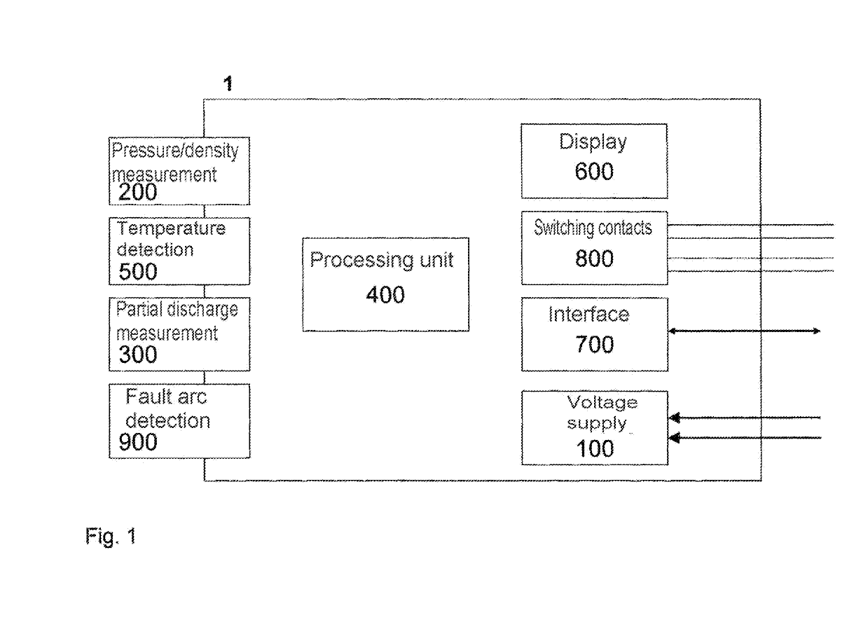

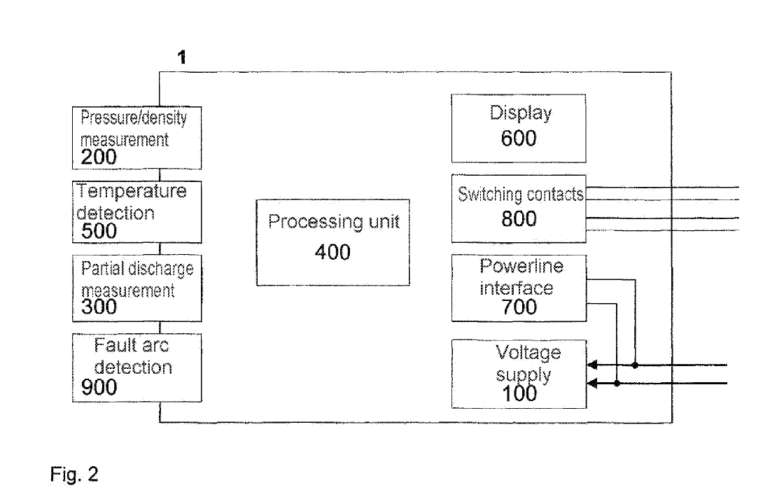

The rest of the description of the disclosure and of the advantages and refinements of the disclosure in the following text can be based on FIGS. 1 and 2 which, by way of example, show an exemplary embodiment of the monitoring unit.

FIG. 1 illustrates a monitoring unit in can be used for monitoring and/or signaling/visualizing a plurality of operating parameters of a gas-insulated switchgear assembly. The monitoring unit includes a current and voltage supply 100 in the housing of the monitoring unit, a pressure measurement cell or density measurement cell 200 and a partial-discharge measurement cell 300. The pressure measurement cell or density measurement cell 200, the pressure measurement cell 100 and the partial-discharge measurement cell 300 project into the gas area of the switchgear assembly.

Electronics that include not only a microprocessor or a microcontroller 400 but also a temperature sensor 500 can also be integrated to the monitoring unit. The measured values detected by the temperature sensor 500, the pressure measurement cell, or density measurement cell 200 and the partial-discharge measurement cell 300, such as temperature, pressure or pressure rise in the inert gas, attraction of the free electrons and/or the number of fluoro ions, can be made available to the microprocessor 400 for further processing.

The microprocessor 400 processes the measured values provided, and transmits the processed measured values as analog and binary signals to a communication interface 700, which is integrated in the monitoring unit, and to a display unit 600.

The microprocessor 400 can also be connected to at least two binary switching contacts 800, which detect overshooting or undershooting of limit values and thus emit warning and blocking messages. Alternatively, the binary switching contacts can also be mechanically connected directly to the measurement cell 200.

FIG. 2 illustrates a communication interface in accordance with an exemplary embodiment. The communication interface 700 allows a monitoring PC to be linked to a superordinate control and implementation system. The interface 700 can include, for example, an Ethernet interface or a PowerLine transmission 800.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A monitoring unit for monitoring and/or signaling/visualizing a plurality of operating parameters of a gas-insulated switchgear assembly, comprising:
a current and voltage supply unit, which is located in a housing of the monitoring unit;
at least one measurement cell for detection of a density or pressure of an inert gas which is located in a gas area of the gas-insulated switchgear assembly; and
a processing unit that processes parameters detected by the measurement cell,
wherein the monitoring unit also comprises at least one of:
an interface for the transmission of analog and digital values;
a unit for partial-discharge measurement; and
a unit for detection of a fault arc which has occurred in the gas area of the switchgear assembly.

2. The monitoring unit of claim 1, wherein the monitoring unit has at least two binary switch contacts, which detect undershooting of a limit value.

3. The monitoring unit of claim 1, wherein the monitoring unit has a unit for at least one of temperature measurement and temperature compensation.

4. The monitoring unit of claim 1, wherein the monitoring unit has a display unit for visualizing one or more parameters which are detected by the monitoring unit.

5. The monitoring unit of claim 1, wherein the processing unit is a microprocessor.

6. The monitoring unit of claim 1, wherein the monitoring unit has a communication interface for data interchange with a superordinate system.

7. The monitoring unit of claim 4, wherein the communication by means of the communication interface with the superordinate system can be carried out via an Ethernet and/or a PowerLine network.

8. The monitoring unit of claim 1, wherein the unit for detection of the fault arc is an optical sensor.

9. The monitoring unit of claim 1, wherein the unit for partial-discharge measurement is an ion detector.

10. The monitoring unit of claim 1, wherein the processing unit detects the parameters determined by the measurement cell for detection of the density or the pressure of the inert gas which is located in the gas area of the switchgear assembly and provides compensation by means of the temperature which is measured at that time by the unit for at least one of temperature measurement and temperature compensation.

11. The monitoring unit of claim 1, wherein the monitoring unit is provided for configuration of various limit values and response thresholds.

12. The monitoring unit of claim 1, wherein the measurement cell for detection of the density or of the pressure of the inert gas which is located in the gas area of the gas-insulated switchgear assembly is a pressure measurement cell or a density measurement cell.

13. The monitoring unit of claim 1, wherein the measurement cell for detection of the density or of the pressure of the inert gas which is located in the gas area of the switchgear assembly, and the unit for partial-discharge measurement, project into the gas area of the switchgear assembly.

14. A method for monitoring a plurality of operating parameters of gas-insulated switch gear assembly, the method performed by a monitoring unit comprising:
measuring a valve for at least one of temperature, pressure, density;
processing the measured values;
comparing the processed values to a limit value to detect an overshoot or undershort of the limit values; and
emitting a warning or a blocking signal based on the comparison.

15. The method of claim 14, comprising:
transmitting the processed values to a communication interface.
